(19) United States
(12) Patent Application Publication
(10) Pub. No.: US 2017/0128959 A1
(43) Pub. Date: May 11, 2017

(54) SPRAY HEAD

(71) Applicant: SHIN TAI SPURT WATER OF THE GARDEN TOOLS CO., LTD., LU-KANG TOWN (TW)

(72) Inventor: Chin-Yuan Chen, LU-KANG TOWN (TW)

(21) Appl. No.: 14/938,779

(22) Filed: Nov. 11, 2015

(51) Int. Cl. B05B 1/16; B05B 9/01; B05B 1/12

(52) U.S. Cl. CPC B05B 1/1654; B05B 1/12; B05B 1/169; B05B 9/01

(57) ABSTRACT

A spray head has: a main body, a distributing portion, a rotatable cover and a sprinkler head. The main body has a handle and a chamber. The chamber is connected to the distributing portion, and the distributing portion has an outlet channel connected to the inner channel of the main body. The distributing portion further includes a center rod for engaging with the sprinkler head. The distributing portion further includes a tapered connecting section protruding from the main body, the connecting section is jacketed with the rotatable cover, and the rotatable cover is engaged with the sprinkler head.

### BACKGROUND OF THE INVENTION

1. Field of the Invention The present invention relates to a spray head, and more particularly to a spray head with a rotatable cover.

2. Description of the Related Art

As shown in FIG. 6 and FIG. 7, a current conventional spray gun 50 is provided with a main body 51 formed with an enlarged outlet 511 at a front end. A distributing portion 52 is combined within the outlet 511, the distributing portion 52 is provided with an outlet channel 521 offsetting to the side, and the outlet channel 521 is connected to an inner channel 512 in the main body 51. A center rod 522 is protruding from the distributing portion 52 and capable of engaging with a sprinkler head 53. Normally, in order to turn the sprinkler head 53 for different options, an outer peripheral wall 531 of the sprinkler head 53 can be gripped and turned by a user.

However, in the practical applications the conventional structure described above still has the following problems: the limited outer peripheral all 531 of the sprinkler head 53 provides small contact area, which can be inconvenient from time to time.

Therefore, it is desirable to provide a spray head to mitigate and/or obviate the aforementioned problems.

### SUMMARY OF THE INVENTION

An objective of the present invention is to provide a spray head.

In order to achieve the above mentioned objective, a spray head has: a main body, a distributing portion, a rotatable cover and a sprinkler head. The main body has a handle and a chamber. The chamber is connected to the distributing portion, and the distributing portion has an outlet channel connected to the inner channel of the main body. The distributing portion further includes a center rod for engaging with the sprinkler head. The distributing portion further includes a tapered connecting section protruding from the main body, the connecting section is jacketed with the rotatable cover, and the rotatable cover is engaged with the sprinkler head. The enlarged sprinkler head provides a larger contact area for the user, so it is easier to rotate the sprinkler head even when the user has wet hands or the sprinkler head jammed by built up water impurities.

Other objects, advantages, and novel features of the invention will become more apparent from the following detailed description when taken in conjunction with the accompanying drawings.

### BRIEF DESCRIPTION OF THE DRAWINGS

FIG. 1 is a perspective drawing of an embodiment according to the present invention.

FIG. 2 is an exploded view of the embodiment according to the present invention.

FIG. 3 is a cross-sectional view of the embodiment according to the present invention.

FIG. 4 is another cross-sectional view of the embodiment according to the present invention.

FIG. 5 is a schematic drawing showing the rotatable cover driving the sprinkle head.

FIG. 6 is a schematic drawing showing a prior art sprinkle head.

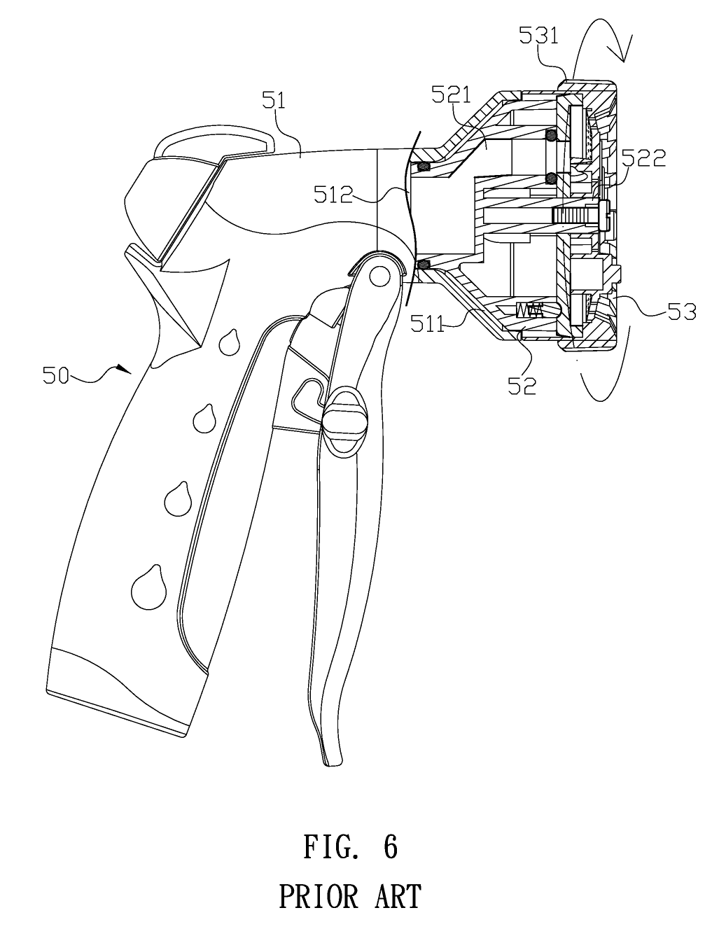

FIG. 7 is a cross-sectional view of the prior art sprinkle head.

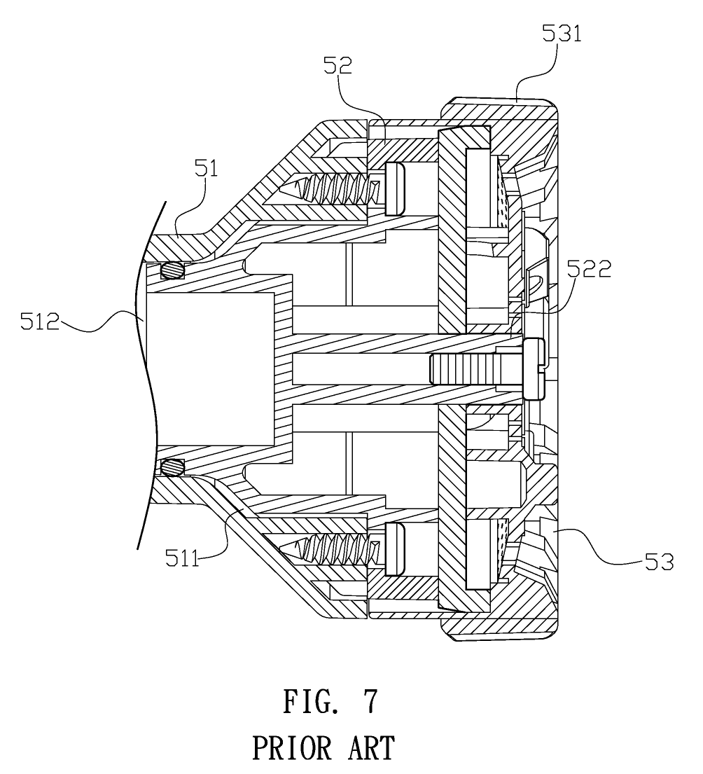

### DETAILED DESCRIPTION OF THE PREFERRED EMBODIMENT

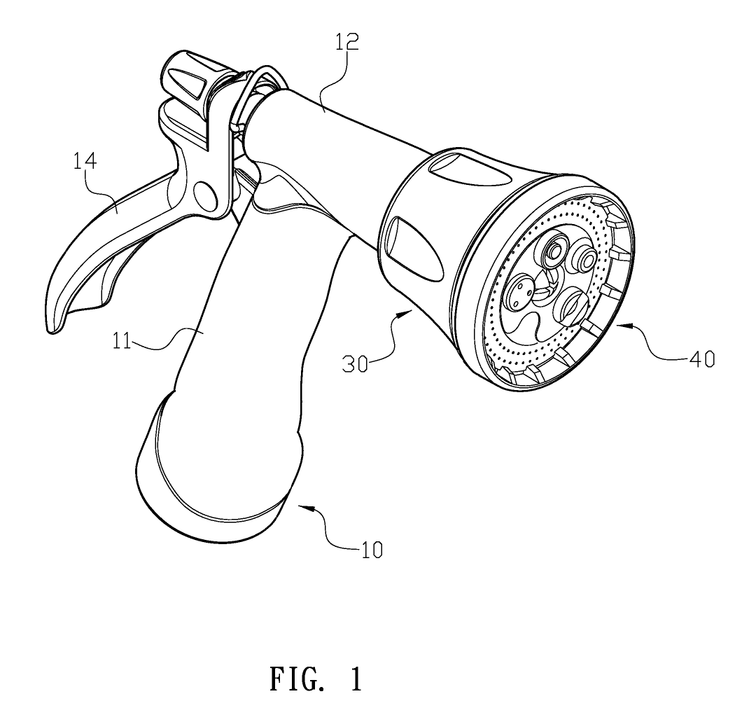

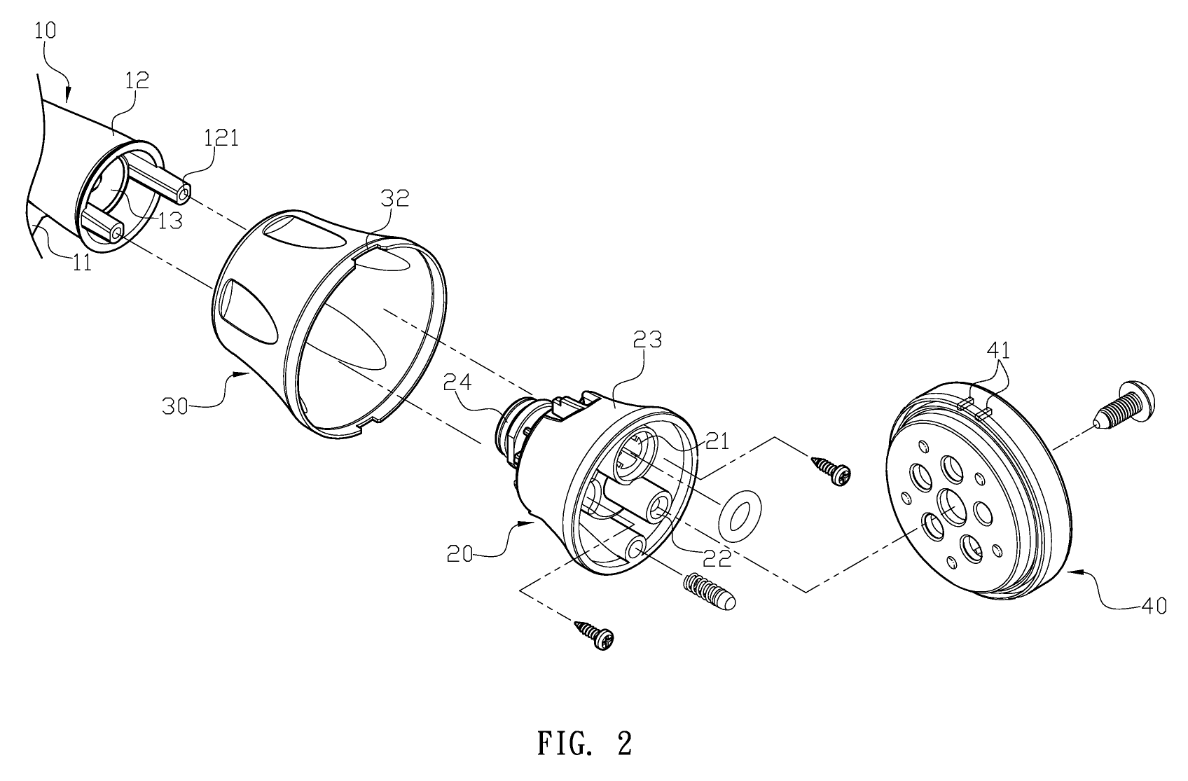

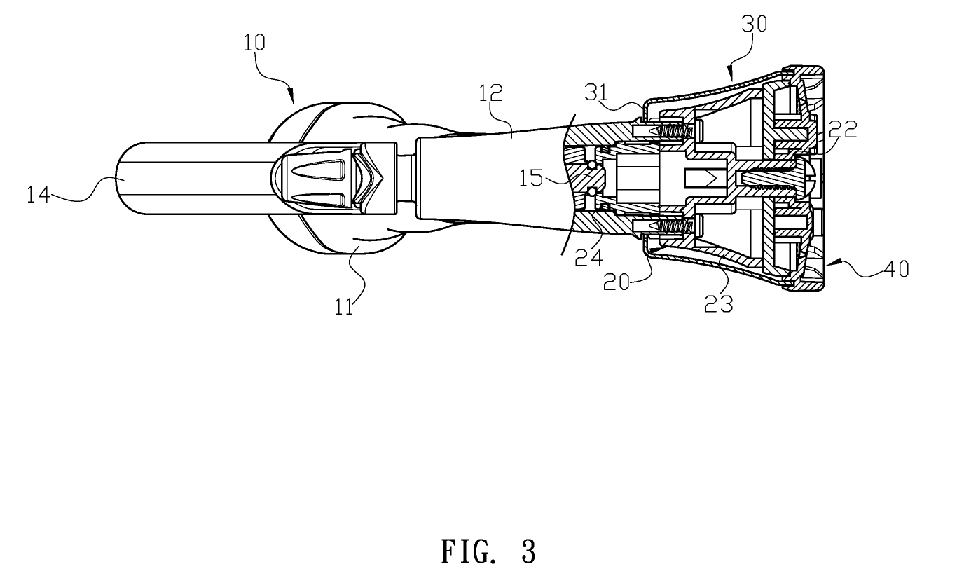

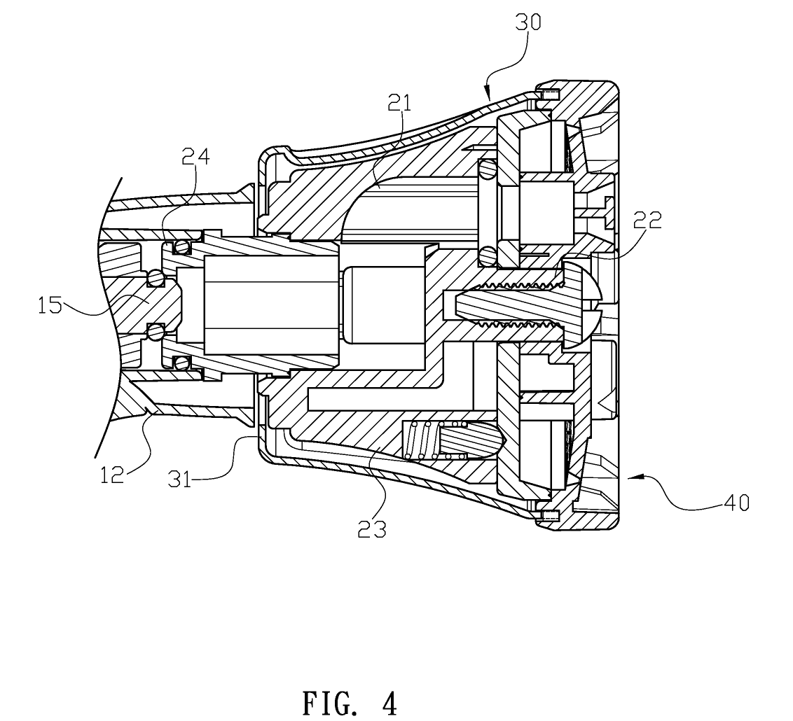

Please refer to FIG. 1 to FIG. 4. A spray head comprises: a main body 10, a distributing portion 20, a rotatable cover 30 and a sprinkler head 40. The main body 10 has a handle 11 and a chamber 12. The chamber 12 is connected to the distributing portion 20, and the distributing portion 20 has an outlet channel 21 connected to the inner channel 13 of the main body 10. The distributing portion 20 further includes a center rod 22 for engaging with the sprinkler head 40. The distributing portion further includes a tapered connecting section 23 protruding from the main body 10, the connecting section 23 is jacketed with the rotatable cover 30, and the rotatable cover 30 is engaged with the sprinkler head 40. The enlarged sprinkler head 40 provides a larger contact area for the user, so it is easier to rotate the sprinkler head 40 even when the user has wet hands or the sprinkler head 40 jammed by built up water impurities.

Furthermore, the main body 10 further comprises a pressing member 14, and a valve rod 15 is disposed in the chamber 12 and capable of being driven and controlled by the pressing member 14.

In addition, at least two locking apertures 121 are provided at a front edge of the chamber 12, and the locking apertures are used for combining the chamber 12 with the distributing portion 20.

The distributing portion 20 further comprises a tubular sleeve section 24 at another end inserted into the chamber 12 and connected with the outlet channel 21.

The outlet channel 21 and the center rod 22 are disposed in the connecting section 23.

Moreover, a lip 31 is provided at a rear side of the rotatable cover 30. When the rotatable cover 30 is jacketed onto the distributing portion 20, the distributing portion 20 is connected with the chamber 12, and the lip 31 is sandwiched between the chamber 12 and the connecting section 23, which limits the linear movement of the rotatable cover 30.

Moreover, at least one engaging opening 32 is provided at a front side of the rotatable cover 30, and at least one corresponding engaging member 41 is provided at a rear side of the sprinkle head 40. By engaging the engaging opening 32 and the engaging member 41, the rotatable cover 30 and the sprinkler head 40 are combined together.

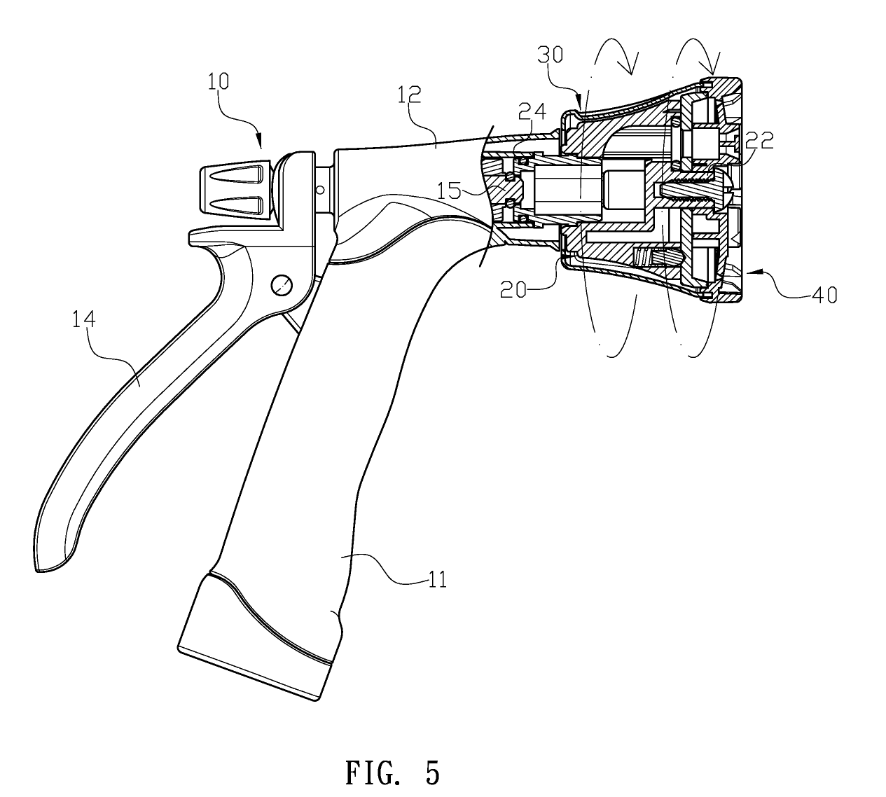

When the user rotates the rotatable cover 30, the sprinkler head 40 is driven by the rotatable cover 30, as shown in FIG. 5. Therefore it is easier to rotate the sprinkler head 40 even when the user has wet hands or the sprinkler head 40 jammed by built up water impurities.

Although the present invention has been explained in relation to its preferred embodiment, it is to be understood that many other possible modifications and variations can be made without departing from the spirit and scope of the invention as hereinafter claimed.

What is claimed is:

1. A spray head comprising: a main body, a distributing portion, a rotatable cover and a sprinkler head, characterized in that:
the main body has a handle and a chamber with an inner channel, the chamber connected to the distributing portion, and the distributing portion has an outlet channel connected to the inner channel of the main body, the distributing portion further including a center rod for engaging with the sprinkler head; and
the distributing portion further includes a connecting section protruding from the main body, the connecting section jacketed with the rotatable cover, and the rotatable cover is engaged with the sprinkler head.

2. The spray head as claimed in claim 1, wherein the main body further comprises a pressing member, and a valve rod is disposed in the chamber and capable of being driven and controlled by the pressing member.

3. The spray head as claimed in claim 1, wherein at least two locking apertures are provided at a front edge of the chamber, the locking apertures used for combining the chamber with the distributing portion.

4. The spray head as claimed in claim 1, wherein the connecting section is tapered.

5. The spray head as claimed in claim 1, wherein the distributing portion further comprises a tubular sleeve section at another end inserted into the chamber and connected with the outlet channel.

6. The spray head as claimed in claim 1, wherein the outlet channel and the center rod are disposed in the connecting section.

7. The spray head as claimed in claim 1, wherein a lip is provided at a rear side of the rotatable cover; wherein when the rotatable cover is jacketed onto the distributing portion, the distributing portion is connected with the chamber, and the lip is sandwiched between the chamber and the connecting section.

8. The spray head as claimed in claim 1, wherein at least one engaging opening is provided at a front side of the rotatable cover, and at least one corresponding engaging member is provided at a rear side of the sprinkle head; wherein by engaging the engaging opening and the engaging member, the rotatable cover and the sprinkler head are combined together.
